(19) United States
(12) Patent Application Publication
(10) Pub. No.: US 2025/0101320 A1
(43) Pub. Date: Mar. 27, 2025

(54) INTEGRATED STAGING HYDROPROCESSING REACTION VESSEL

(71) Applicant: Indian Oil Corporation Limited, Mumbai (IN)

(72) Inventors: Arun ARANGARASU, Faridabad (IN); Yamini GUPTA, Faridabad (IN); Nepal VISWAKARMA, Faridabad (IN); Ganesh Vitthalrao BUTLEY, Faridabad (IN); Sarvesh KUMAR, Faridabad (IN); Madhusudan SAU, Faridabad (IN)

(73) Assignee: Indian Oil Corporation Limited, Mumbai (IN)

(21) Appl. No.: 18/826,511

(22) Filed: Sep. 6, 2024

(30) Foreign Application Priority Data
Sep. 21, 2023 (IN) 202321049445

(51) Int. Cl. C10G 49/00; B01J 8/00; B01J 8/02; C10G 45/28

(52) U.S. Cl. CPC C10G 49/002; B01J 8/0065; B01J 8/0257; B01J 8/0285; C10G 45/28; B01J 2208/0053; B01J 2208/00911; B01J 2208/0092; B01J 2208/00991; B01J 2208/027; C10G 2300/4018; C10G 2300/4037

(57) ABSTRACT

The present invention relates to an integrated hydro-processing reaction vessel which comprises of all the reactor, separator and stabilization sections integrated in a single vessel or system for hydro-processing of low boiling vapour phase hydrocarbon feed; as primary stream undergoing multitude of mass transfer stages with the heavy boiling liquid phase hydrocarbon feed; as secondary stream.

### FIELD OF THE INVENTION

The present invention relates to hydro-processing reaction vessel apparatus and its associated components integrated in such a way for effective heat transfer and reactive mass transfer of low boiling hydrocarbon feed undergoing multitude of mass transfer stages with the heavy boiling hydrocarbon feed across the catalyst bed section.

### BACKGROUND OF THE INVENTION

There is extensive amount of research work already available in the art of design and/or configuration and/or intensification of hydro-processing vessel and/or process, prevailing with various scopes for continuous improvement in the field of hydro-processing. Integration of specific functional unit operations like separators, strippers, other any associated heat & mass transfer equipment, etc. along with reactors always remained as a cost-effective approach and model for execution of any hydro-processing reactions. In line to the present invention disclosed herein, the prior arts are sequentially discussed about integrated apparatus, various flow configuration approaches like co/counter current along with/without integration, staging with respect to reaction mechanism and mass transfer and finally about the relevant processes involved in the hydro-processing of low boiling hydrocarbons.

The H₂S present in the hydro-processing system either in the hydrocarbon feed or intermittent reactor or catalyst bed effluent is mainly considered to be the governing case, dealing which demands for opportunities in field of process integration, reaction staging and flow configurations and so on.

U.S. Pat. No. 10,604,708 proposes an intensified hydro-processing reactor with combined functionality of hot high-pressure separator by which, the multistage effect in hydro treatment is introduced by simultaneous removal of H₂S in every stage to avoid formation of recombinant mercaptan. This invention is also related to carrying out the hydro-processing reaction in liquid phase in multitude of stages for obtaining ultra-low sulphur in diesel.

U.S. Pat. No. 6,007,787 discloses an invention on modified counter current reaction vessel than the conventional counter current reaction vessel, in which the flooding is less susceptible because of vapour passageways, which act to selectively bypass a fraction of the upward flowing treat gas through one or more of the catalyst beds. The fraction of upward flowing treat gas that bypasses a catalyst bed increases as the vapour pressure drop increases through the catalyst bed, by which the vapour passageways provide a self-adjusting regulation of upward flowing vapour and hence extending the hydrodynamics operating window of the reaction vessel.

EP1017488 relates to a counter current reactor design for processing liquid feedstock and hydrogen rich treat gas. This design discloses various alternate embodiments to address the accumulated liquid hold-up in the bed, caused by flooding either due to higher upward flowing gas rate or higher downward flowing liquid rate. Internal conduit with various alternate arrangements in lower and upper section is being used to regulate the bypass of excess liquid resulting in hold-up due to flooding.

US20050035026A1 discloses a catalytic distillation apparatus and hydroprocessing method for effective treatment of long chain hydrocarbon molecules. The reactor contains catalyst bed in the middle, wherein the liquid hydrocarbon is injected in the middle or above the catalyst bed depending upon the chain length of hydrocarbon and the hydrogen rich gas flows counter currently with hydrocarbon.

U.S. Pat. No. 7,435,336 proposes gas-liquid counter current process in which the voidage between the adjacent catalyst layers is varied to improve stability and process flexibility. The voidages of the catalyst layer are selected based on the vaporizing behaviour of reactants and number of small molecules formed during reactions. In the case of reaction systems involving big change in the volumes of gas and liquid phases, the difference of voidages between the adjacent catalyst layer is relatively big and vice-versa.

Staging in hydroprocessing may be broadly classified with respect to reaction kinetics occurring in different catalyst beds and/or with respect to internal mass transfer among reactants to products, vice versa within one or more of a catalyst bed. Those already skilled in the art are aware that most of the staging mechanisms with or without integration are related to the regulation of kinetics in different catalyst beds than within the catalyst bed, as disclosed in the present invention.

U.S. Pat. No. 5,705,052 discloses a multistage hydroprocessing process in a single reaction vessel. Each reaction stage is followed by a non-reaction stage, wherein the first reaction stage with respect to the flow of hydrocarbon feedstock is the last reaction stage with respect to the flow of treat gas and both the feedstock and treat gas flows co-currently in the reaction vessel. The treated liquid component is further stripped in a separate vessel with counter-current flow of steam as stripping medium. The same multistage hydroprocessing process in different reaction vessels configuration along with a single stripper column is proposed in U.S. Pat. No. 5,720,872.

U.S. Pat. No. 6,054,041 discloses a hydroprocessing process configuration utilizing three stages, wherein the first stage operation occurs in a separate reactor vessel and the subsequent second stage (for liquid) and third stage (for vapour) occurs in a separate vessel. The by-products of hydroprocessing in the first stage like H₂S and NH₃ are routed to the third vapour stage and their concentrations are controlled and regulated in the second liquid stage operation. The first stage treated liquid hold-up separates the second and third stage section and the controlling mechanism of this liquid hold-up on inter-stage tray can be either associated with the vapour stage section or the liquid stage section.

U.S. Pat. No. 6,017,443 relates to a novel hydroprocessing process configuration with staged reaction zones, which utilizes co-current downflow of liquid feed through catalyst beds. The reacted liquid effluent is partially pumped back to the top section of catalyst bed to undergo staging effect of the system.

U.S. Pat. No. 6,623,622 relates to a novel two stage Hydrotreating process along with a stripping section in a single reaction vessel. The reaction vessel comprises of two catalysts beds (top & bottom) and a stripping section below the bottom catalyst bed. The bottom catalyst bed acts as first stage by treating the fresh incoming feed and then routed to an intermittent stripper, through which the reactor effluent is taken out from the bottom-most of reaction vessel and routed to top catalyst bed acting as the second stage and the treated final product is taken out below the non-reaction zone of second stage. The inventor of same disclosed the same for two stage hydroprocessing and stripping in a single reaction vessel in U.S. Pat. No. 6,632,350.

US20040251169A1 discloses a hydrotreating process, in which the reactor effluent of any Hydrotreating reactor system is further treated in steps as per the requirement of stages in the operation of hydrotreating. The reactor effluent is hot flashed at the top of reactor and the liquid-gas mixture is routed to catalyst bed and the effluent moves to a separator section wherein, the surplus gas is mixed with the main off-gas purge line through pressure equalization line and the predominant liquid stream from bottom is sent to other similar process setup for subsequent staging operation of hydrotreatment.

The so far disclosed patents mainly focused discussion over integrating various unit operations along with reactor utilizing staging effects in the area of hydroprocessing and further subsequent discussion are focused on utilizing these systems for effective treatment or hydroprocessing of low boiling Carbon Chain length (C4-C5) hydrocarbon feed, significantly for removal of mercaptans and H₂S and its associated processes.

U.S. Pat. No. 7,342,145 discloses a process for removing sulfur containing compound from liquefied petroleum gas (LPG) in a fixed bed reactor for adsorption of H₂S using a catalyst comprising an active component selected from the group consisting of a FeCa oxide and a FeCa oxide hydrate for mercaptan conversion and by converting the mercaptans into disulfides by reacting with air and in presence of catalyst. US20020043154A1 discloses a method to remove sulfur compounds from a gas having propylene up to 30 percent using zeolite catalyst. The zeolite compound comprises less than 5 percent water. Useful zeolites include X, Y and faujasite. Zeolite can be ion exchanged with ions such as zinc ions.

US20210292670A1 discloses a process for removal of sulfur and other impurities from mixed olefinic Liquefied Petroleum Gas (LPG). Mixed olefinic LPG streams comprising isobutene from various cracking processes of refinery/petrochemical units are routed to a reactor in a reaction zone, wherein the olefins present in the feedstock react with the organic sulfur present in the feed stock and form heavier sulfides. The olefin preferably isobutene reacts instantaneously with the feed sulfur components and forms respective heavier sulfides in the reaction zone. In the reaction zone, the olefins, preferably C4 olefins also react and form a liquid product comprising dimers, trimers, and tetramers, which in turn react with sulfur compounds and form heavier sulfides. The formed dimer compounds react with the mercaptan and form its corresponding sulfide component. Oxygenate components are added to modify the catalyst acidity which in turn controls the conversion and selectivity of the dimerization reaction.

U.S. Pat. No. 11,041,130 discloses a process which converts olefins and/or diolefins present in sulphur containing refinery distillate streams via a mercaptanization and/or thiophenization reaction to provide an olefin-free sulfur containing stream for processing in hydrodesulfurization unit. Thiophenization reactions typically involve the formation of thiophene through the addition of H₂S to dienes/diolefins in the presence of acid catalysts such as silica-alumina, alumina, silica-titania, or zeolites with acidity modifiers with active phase metals. For example, thiophene (C₄H₄S) can be synthesized from the catalytic addition of hydrogen sulphide to butadiene.

### SUMMARY OF THE INVENTION

The present invention discloses an integrated staging hydro-processing reaction vessel (100, 200), wherein the vessel comprises a top portion, a middle portion, and a bottom portion. The top portion acts as a stabilizer section (107, 229) consisting of a demister (106, 228) at a top part of the stabilizer section (107, 229). Wherein, the middle portion acting as a reactor section (108, 230) consisting of a hydro-processing catalyst bed (111, 233) in the middle part of the reactor section (108, 230), the reactor section (108, 230) comprises of two distributors; a liquid phase distributor (110, 232) located at a top part of the reactor section (108, 230), and a vapour phase distributor (114, 234) located at a bottom part of the reactor section (108, 230). Wherein a secondary stream (103, 223) of heavy boiling hydrocarbons enters the top part of the reaction vessel through the liquid phase distributor (110, 232) which is located at the top part of reactor section, and a primary stream (101, 221) along with a hydrogen rich treat gas stream (117, 240) enters the bottom part of the reaction vessel (100, 200) and get distributed through the vapour phase distributor (114, 234) which is located at the bottom part of reactor section, wherein a volumetric ratio of hydrogen to the primary stream is in the range of 0.5 to 10 Nm³/m³.

The bottom portion acting as a separator section (109, 231) consisting of a liquid seal mechanism (115, 235) containing an inverted outer pipe (118, 241), wherein the inverted outer pipe (118, 241) has a seal at a top part and a perforated opening (120, 243) at a bottom part thereof, and an inner annular pipe (119, 242) having an externally protruded part (116, 236) extending out from the separator section (109, 231). Wherein in the reactor section (108, 230), the reaction between sulphur compounds of the primary stream (101, 221) and the olefins of the secondary stream (103, 223) results in formation of heavy boiling sulphur compounds in liquid state and heteroatom lean low boiling stream (102, 222), wherein the heavy boiling sulphur compounds are being liquid-phase in nature and hence taken out along with an outgoing secondary stream (104, 224) and the heteroatom lean low boiling stream (102, 222) is withdrawn from a topmost section of reaction vessel (100).

The demister (106, 228) is made of a mesh type coalescer arrangement which is adapted to restrict the entrainment of liquid, and a treated vapour stream is withdrawn from the top part through the mesh type coalescer arrangement.

The reactor section (108, 230) has a volume equivalent to 0.5 to 5 liquid hourly space velocity (LHSV) of the primary stream (101, 221). Further, the volume of reactor section is 20 to 40% of a volume of the entire reaction vessel (100, 200), a volume of separator section is 40 to 60% to the volume of reactor section and a volume of the stabilizer section is 60 to 80% to the reactor section.

The primary stream is effectively heat integrated and moves upward through the reactor section (108, 230) and a treated primary stream comes out through a top part of the stabilizer section (107, 229). The secondary stream (103, 223) is effectively heat integrated and moves downward in the reactor section (108, 230) and a reacted secondary stream comes out through a bottom part of the separator section (109, 231), wherein, inside the reactor section (108, 230) the primary stream and the secondary stream undergoes hydro-processing along an entire length of the reactor section (108, 230), and wherein the secondary stream (103, 223) exothermically reacts with the primary stream (101, 221) and generates in-situ heat load.

The primary stream (101, 121) consists of low boiling hydrocarbons and sulphur compounds, and the primary stream (101, 121) enters the reactor section in a vapour phase. Further, a flow rate of the primary stream is controlled and regulated within 30% to 50% of a flooding velocity regime thereof. The secondary stream (103, 223) of heavy boiling hydrocarbons is in liquid phase and consists of olefinic compounds, wherein the said primary and secondary streams are integrated for effective heat utilization with minimal supply of heat energy from an external source.

The inner annular pipe (119, 242) has a height lesser than the outer inverted pipe (118, 241) and both are aligned to provide steady state flow of the secondary stream (103, 223) in line with the outgoing secondary stream (104, 224), and wherein the externally protruded part (116, 236) is adapted for self-regulating the liquid seal mechanism (115), through the liquid seal mechanism (115, 235) the ingress of gaseous primary stream is restricted and the reaction converted heavy boiling sulphur compounds comes out from the reaction vessel (100, 200) along with the secondary stream (104, 224).

The stabilizer section (107, 229) has a height to enrich the concentration of heteroatom lean low boiling stream (102, 222), wherein the low boiling stream (102, 222) is withdrawn from a topmost section of reaction vessel (100, 200) through the demister (106, 228) by which the entrainment of liquid is stopped.

The liquid phase distributor (110, 232) consists of a vapour lift liquid distribution tray, and the vapour phase distributor (114, 234) consists of a multiple sparger type nozzle located across a circumference of the reaction vessel at a standard pitch distance.

The hydro-processing catalyst bed (111, 233) consist of a solid transient metal hydro-processing catalyst, and the catalyst bed has a voidage in a range of 20 to 50%, more preferably in a range of 25 to 35%.

In one embodiment, the present invention of integrated hydro-processing reaction vessel associated in the hydro-processing process is described under isothermal conditions of heat integration and once-through configuration. In another embodiment of the present invention, the same is described under adiabatic conditions of heat integration and recycle configuration.

### OBJECTIVES OF THE INVENTION

It is a primary objective of the invention which relates to hydro-processing reaction vessel apparatus and its associated components integrated in such a way for effective heat transfer and reactive mass transfer of low boiling hydrocarbon feed along with heavy boiling hydrocarbon stream.

It is the further objective of the present invention related to the integrated hydro-processing reaction vessel associated in the hydro-processing process is described under isothermal conditions of heat integration and once-through configuration.

Further the objective of the present invention is that the integrated hydro-processing reaction vessel operates under adiabatic conditions of heat integration and recycle configuration.

### BRIEF DESCRIPTION OF DRAWINGS

FIG. 1 illustrates a longitudinal cross sectional schematic representation of reaction vessel of the present invention containing three integrated sections of reactor, separator, and stabilizer in a single system of hydro-processing under isothermal conditions and once-through configuration.

FIG. 2 illustrates another embodiment of present invention of reaction vessel containing three integrated sections of reactor, separator, and stabilizer in a single system of hydro-processing under adiabatic conditions and recycle configuration.

FIG. 3 is a representation of liquid loop pressure control mechanism of the reaction vessel depicted in FIG. 1 or FIG. 2.

### DESCRIPTION OF THE INVENTION

In accordance with the present invention, an integrated hydroprocessing reaction vessel which comprises of all the reactor, separator and stabilization sections integrated in a single system for hydroprocessing process comprising two different boiling ranges of hydrocarbon streams/feeds undergoing multitude of mass transfer stages among each other.

The term “primary stream” as used herein refers to the low boiling hydrocarbon stream or feedstock containing organic sulphur compounds.

The term “secondary stream” as used herein refers to the heavy boiling hydrocarbon stream or feedstock containing olefinic compounds, whose olefinic carbon chain length varies preferably in the range of C₃ to C₁₀.

The reaction vessel components associated in the hydroprocessing process are described as; wherein, the middle portion acts as the reactor section comprising active catalyst system; above and below which, the distribution system of liquid and vapour streams are located, respectively. The bottom portion acts as the separator section designed with liquid seal mechanism, by which the ingress of gas is restricted and neat liquid stream is withdrawn from bottom. The top portion acts as the stabilizer section with required disengaging space and the treated enriched vapour stream is withdrawn from top through any typical mesh type coalescer arrangement, by which the entrainment of liquid is stopped.

The primary stream is effectively heat integrated in both cases of isothermal or adiabatic reactor system and enters the bottom of the reactor section, moving upward and eventually comes out at the topmost of the stabilization section. The secondary stream is effectively heat integrated and gains the final process heat duty requirement from external source in either case of isothermal or adiabatic reactor system and enters at the top of the reactor section, moving downward and eventually comes out at the bottom most of the separator section.

Specifically, the present invention discloses an integrated staging hydro-processing reaction vessel (100, 200), wherein the vessel comprises a top portion or a non reacting zone, a middle portion or a reaction zone, and a bottom portion or a non reacting zone. Wherein, the top portion acting as a stabilizer section (107, 229) with a disengaging space consisting of a demister (106, 228), wherein the demister (106, 228) prevents liquid entrainment at a top part of the stabilizer section (107, 229).

Wherein, the middle portion acting as a reactor section (108, 230) consisting of a hydro-processing catalyst (111, 233) in the middle part of the reactor section (108, 230), the reactor section (108, 230) comprises of two distributors; a liquid phase distributor (110, 232) located at a top part of the reactor section (108, 230), and a vapour phase distributor (114, 234) located at a bottom part of the reactor section (108, 230). Wherein a secondary stream (103, 223) of heavy boiling hydrocarbons enters the reaction zone through the liquid phase distributor (110, 232) which is located at the top of reactor section, and a primary stream (101, 221) along with a hydrogen rich treat gas stream (117, 240) enters the bottom part of reaction zone and get distributed through the vapour phase distributor (114, 234) which is located at the bottom of reactor section, wherein a volumetric ratio of hydrogen to the primary stream is in the range of 0.5 to 10 Nm³/m³.

The bottom portion acting as a separator section (109, 231) integrated with a liquid seal mechanism (115, 235) containing an inverted outer pipe (118, 241), wherein the inverted outer pipe (118, 241) has a seal at a top part and a perforated opening (120, 243) at a bottom part thereof, and an inner annular pipe (119, 242) having an externally protruded part (116, 236) extending out from the separator section (109, 231). Wherein in the reactor section (108, 230), the reaction between sulphur compounds of the primary stream (101, 221) and the olefins of the secondary stream (103, 223) results in formation of heavy boiling sulphur compounds in liquid state and heteroatom lean low boiling stream (102, 222), wherein the heavy boiling sulphur compounds are being liquid-phase in nature and hence taken out along with an outgoing secondary stream (104, 224) and the heteroatom lean low boiling stream (102, 222) is withdrawn from a topmost section of reaction vessel (100).

The demister (106, 228) is made of a mesh type coalescer arrangement which is adapted to restrict the entrainment of liquid, and a treated vapour stream is withdrawn from the top part through the mesh type coalescer arrangement.

The reactor section (108, 230) has a volume equivalent to 0.5 to 5 liquid hourly space velocity (LHSV) of the primary stream (101, 221). Further, the volume of reactor section is 20 to 40% of a volume of the entire reaction vessel (100, 200) governed by extent of hydroprocessing and the concentration of reactants in the primary and secondary streams. The volume of separator section is 40 to 60% to the volume of reactor section and a volume of the stabilizer section is 60 to 80% to the reactor section.

The primary stream is effectively heat integrated and moves upward through the reactor section (108, 230) and a treated primary stream comes out through a top part of the stabilizer section (107, 229). The secondary stream (103, 223) is effectively heat integrated and moves downward in the reactor section (108, 230) and a reacted secondary stream comes out through a bottom part of the separator section (109, 231), wherein, inside the reactor section (108, 230) the primary stream and the secondary stream undergoes hydro-processing along an entire length of the reactor section (108, 230), and wherein the secondary stream (103, 223) exothermically reacts with the primary stream (101, 221) and generates in-situ heat load.

The primary stream (101, 121) consists of low boiling hydrocarbons and sulphur compounds, and the primary stream (101, 121) enters the reactor section in vapour phase. Further, a flow rate of the primary stream is controlled and regulated within 30% to 50% of a flooding velocity regime thereof. The secondary stream (103, 223) of heavy boiling hydrocarbons is in liquid phase and consists of olefinic compounds, wherein the said primary and secondary streams are integrated for effective heat utilization with minimal supply of heat energy from an external source.

The inner annular pipe (119, 242) has a height lesser than the outer inverted pipe (118, 241) and both are aligned to provide steady state flow of the secondary stream (103, 223) in line with the outgoing secondary stream (104, 224), and wherein the externally protruded part (116, 236) is adapted for self-regulating the liquid seal mechanism (115), through the liquid seal mechanism (115, 235) the ingress of gaseous primary stream is restricted and the reaction converted heavy boiling sulphur compounds comes out from the reaction vessel (100, 200) along with the secondary stream (104, 224).

The stabilizer section (107, 229) has a height to enrich the concentration of heteroatom lean low boiling stream (102, 222), wherein the low boiling stream (102, 222) is withdrawn from a topmost section of reaction vessel (100, 200) through the demister (106, 228) by which the entrainment of liquid is stopped.

The liquid phase distributor (110, 232) consists of a vapour lift liquid distribution tray, known in the art, and the vapour phase distributor (114, 234) consists of a multiple sparger type nozzle located across a circumference of the reaction vessel at a standard pitch distance.

The hydro-processing catalyst bed (111, 233) consist of a solid transient metal hydro-processing catalyst, and the catalyst bed has a voidage in a range of 20 to 50%, more preferably in a range of 25 to 35%.

In one embodiment, the present invention of integrated hydro-processing reaction vessel associated in the hydro-processing process is described under isothermal conditions of heat integration and once-through configuration. In another embodiment of the present invention, the same is described under adiabatic conditions of heat integration and recycle configuration.

In an embodiment, the reaction vessel (100) further comprises a reactor mounted furnace (112) and a longitudinal pipe (105). Wherein the reactor mounted furnace (112) covers the reactor section (108), wherein the hydro-processing catalyst (111) present in the reactor section (108) achieves a desired temperature of hydro-processing from the reactor mounted furnace (112). The longitudinal pipe (105) extends through a pathway (113) from the stabilizer section (107) to the reactor section (108), wherein the longitudinal pipe (105) have an upper end located above the stabilizer section (107) and a lower end located below the reactor section (108), wherein, the vapour phase distributor (114) is connected with the lower end of the said longitudinal pipe (105). The primary stream (101) along with the hydrogen rich treat gas (117) gains heat from the reactor section (108) in the pathway (113) to the vapour phase distributor (114), and the heat from the reactor section (108) converts primary stream (101) into a vapour phase and resulting in upward movement.

In an embodiment, the reaction vessel (100) further comprises a steam heater (227), a primary stream heat exchanger (238) and a secondary stream heat exchanger (226). Wherein, the steam heater (227) is adapted to provide desired temperature to the secondary stream (223). The primary stream heat exchanger (238) and a secondary stream heat exchanger (226), wherein the primary stream (221) gets an initial heat duty from the primary stream heat exchanger (238) and a final heat duty from the secondary stream heat exchanger (226).

In another embodiment, the reaction vessel (200) further comprises an outgoing secondary stream enrichment section connected with the outgoing secondary stream (224), wherein, the enrichment section consists of a purge section (237) adapted to bleed out definite quantity from the outgoing secondary stream (224), a fresh secondary stream input (244) post purging (237) adapted to provide an equivalent quantity of the fresh secondary stream, and a pumping mechanism (225) adapted to recycle the outgoing secondary stream (224) along with the fresh secondary stream back into the reactor section.

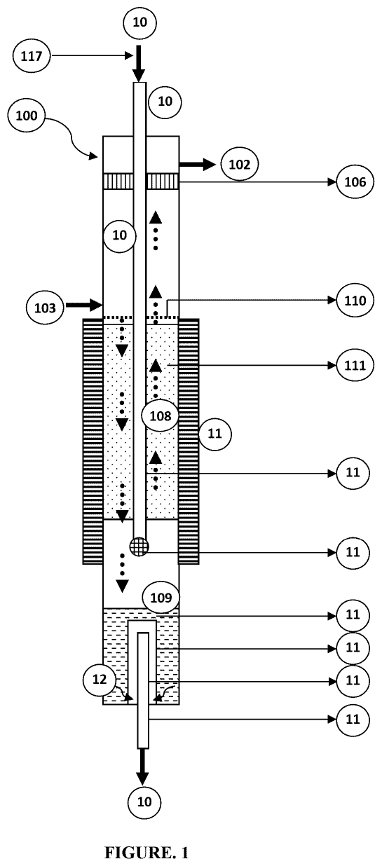

The term hydro-processing is well versed in the field by effective utilization of hydrogen or hydrogen rich treat gas reacts with hydro-carbonaceous feed on severe process conditions over catalyst to remove one or more heteroatom impurities such as sulphur, nitrogen and oxygen in any integrated apparatus or vessel which aids in separation of desired product from its undesired product or feed. FIG. 1 is a simplified longitudinal cross sectional schematic representation of reaction vessel of the present invention containing three integrated sections of reactor, separator, and stabilizer in a single system of hydro-processing process under isothermal conditions and once-through configuration. The hydro-processing reaction vessel (100) comprises of three integrated sections namely stabilizer (107) section, reactor (108) section and separator (109) section. The reactor section (108) containing the hydro-processing catalyst (111) is located in the middle of the reaction vessel, above and below represents the non-reacting zones (or) sections.

The primary stream (101) of low boiling hydrocarbon feed containing organic sulphur compounds enters the reaction vessel through a longitudinal pipe (105) and gets distributed through vapour phase distributor (114), located below the reactor section. The vapour phase distributor (114) is typically a multiple sparger type nozzle design located across the circumference of entire vessel cross section with standard pitch distance as well known in the art of gas-liquid distribution system.

The secondary stream (103) of heavy boiling hydrocarbon feed containing olefinic compounds enters the reaction vessel through liquid phase distributor (110), located above the reactor section. The liquid phase distributor (110) is typically of vapour lift liquid distribution tray type as well known in the art of gas-liquid distribution system. The catalyst (111) present in the reactor section (108) achieves the required temperature of hydro-processing from the reactor mounted furnace (112). The volume of reactor section (108) is defined as the volume equivalent to 0.5 to 5 liquid hourly space velocity (LHSV) of the primary stream. The primary stream (101) along with the hydrogen rich treat gas (117), together gains required temperature from reactor section (108) in its pathway (113) to distributor (114) and ensures its vapour phase post effective heat utilization resulting in upward movement. The secondary stream (103) in liquid phase moves downward and the in-situ generated heat load due to exothermicity of the hydro-processing reaction between two streams in the reactor zone, aids in optimizing the external heat load requirement on furnace (112). The reactive shift reaction between mercaptans or H₂S present in primary stream and the olefins present in the secondary stream results in formation of heavy mercaptans and/or heavy sulphides or heavy boiling sulphur compounds of high boiling range in liquid state eventually ending up in outgoing secondary stream (104).

The outgoing primary stream in vapour state is a treated and heteroatom lean low boiling stream (102) comes out at the topmost section of reaction vessel (100). The upper non-reacting section is meant for separating the treated primary stream in vapour state and the height of the stabilizer section (107) is such that the concentration of treated stream is enriched and taken out as product (102). The entrainment of liquid is avoided through any of the several types of typical mesh type coalescer arrangement or demister (106) like mechanism skilled in the art located at the topmost of stabilizer section. The outgoing secondary stream in liquid state is heteroatom rich heavy boiling stream (104), also called reacted secondary stream comes out at the bottom most section of reaction vessel (100). The lower non-reacting section is meant for separating the reacted secondary stream in liquid state and the height of the separator section (109) is such that the un-reacted or non-treated primary stream from (114) is restricted to come out of the bottom most section through a self-regulating liquid seal mechanism (115). The reacted secondary stream is taken out (104) from the reaction vessel (100) through a self-regulating liquid seal mechanism (115) containing inverted outer pipe (118) sealed at its top and perforated opening (120) at its bottom. An inner annular pipe (119) of height lesser than the outer inverted pipe (118), externally protruded through (116) is meant for self-regulating the liquid seal mechanism through which the reacted secondary stream is taken out of reaction vessel. The height of the external pipe (118) and internal pipe (119) are aligned such that to provide steady state flow of incoming secondary stream (103) in line with the outgoing secondary stream (104). In this embodiment of invention, both the primary and secondary streams are depicted in once through flow configuration.

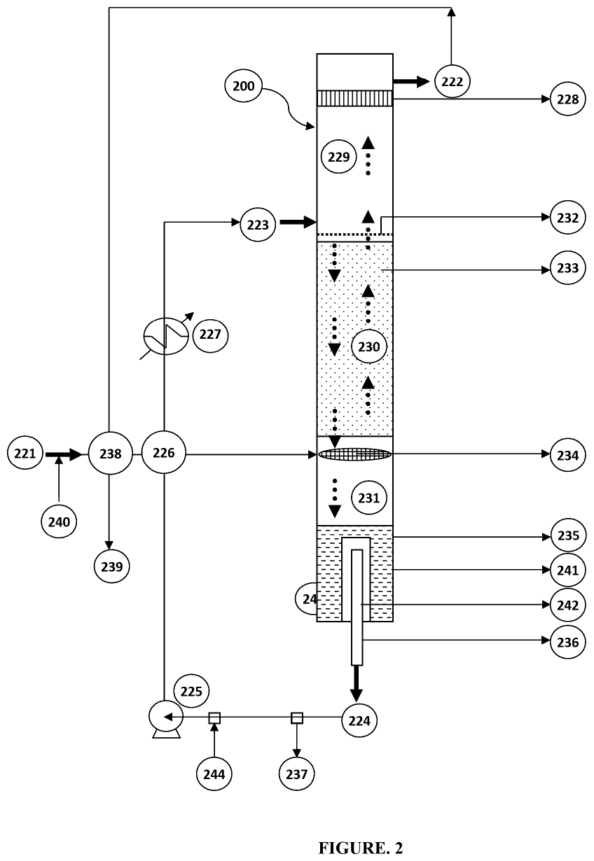

FIG. 2 is a simplified longitudinal cross sectional schematic representation of reaction vessel of the present invention containing three integrated sections of reactor, separator, and stabilizer in a single system of hydro-processing process under adiabatic conditions and recycle configuration. The hydro-processing reaction vessel (200) comprises of three integrated sections namely stabilizer (229) section, reactor (230) section and separator (231) section. The reactor section (230) containing the hydro-processing catalyst (233) is located in the middle of the reaction vessel, above and below represents the non-reacting zones (or) sections. The volume of reactor section (230) is defined as the volume equivalent to 0.5 to 5 liquid hourly space velocity (LHSV) of the primary stream.

The primary stream (221) of low boiling hydrocarbon feed containing organic sulphur compounds enters the reaction vessel by gaining the desired heat duty initially with the primary stream feed/effluent heat exchanger (238) and finally with the secondary stream feed/effluent heat exchanger (226) and eventually gets distributed through vapour phase distributor (234), located below the reactor section. The vapour phase distributor (234) is typically a multiple sparger type nozzle design located across the circumference of entire vessel cross section with standard pitch distance as well known in the art of gas-liquid distribution system. The secondary stream (223) of heavy boiling hydrocarbon feed containing olefinic compounds enters the reaction vessel through liquid phase distributor (232), located above the reactor section. The liquid phase distributor (232) is typically of vapour lift liquid distribution tray type as well known in the art of gas-liquid distribution system. The catalyst (233) present in the reactor section (230) is an insulated system behaving like an adiabatic system, achieves the required temperature of hydroprocessing from the incoming heated primary (221) and secondary streams (223). The primary stream (221) along with the hydrogen rich treat gas (240), together gains required temperature from feed/effluent heat exchangers (238) & (226) in its pathway to distributor (234) and ensures its vapour phase post effective heat utilization resulting in upward movement. The secondary stream (223) in liquid phase moves downward and the exothermicity of the hydroprocessing reaction between two streams, aids in optimizing the heat load on process steam heater (227). The reactive shift reaction between mercaptans or H₂S present in primary stream and the olefins present in the secondary stream results in formation of heavy mercaptans and/or heavy sulphides or heavy boiling sulphur compounds of high boiling range in liquid state eventually ending up in outgoing secondary stream (224).

The outgoing primary stream in vapour state is a treated and heteroatom lean low boiling stream (222) comes out at the topmost section of reaction vessel (200). The upper non-reacting section is mainly meant for separating the treated primary stream in vapour state and the height of the stabilizer section (229) is such that the concentration of treated stream is enriched and taken out as product (239), post effective heat utilization in the primary stream feed/effluent heat exchanger (238). The entrainment of liquid is avoided through any of the several types of any typical mesh type coalescer arrangement or demister (228) like mechanism skilled in the art located at the topmost of stabilizer section. The outgoing secondary stream in liquid state is heteroatom rich heavy boiling stream (224), also called reacted secondary stream comes out at the bottom most section of reaction vessel (200). The lower non-reacting section is meant for separating the reacted secondary stream in liquid state and the height of the separator section (231) is such that the un-reacted or non-treated primary stream from (234) is restricted to come out of the bottom most section through a self-regulating liquid seal mechanism (235). The reacted secondary stream is taken out (224) from the reaction vessel (200) through a self-regulating liquid seal mechanism (235) containing inverted outer pipe (241) sealed at its top and perforated opening (243) at its bottom. An inner annular pipe (242) of height lesser than the outer inverted pipe (241), externally protruded through (236) is meant for self-regulating the liquid seal mechanism through which the reacted secondary stream is taken out of reaction vessel. The height of the external pipe (241) and internal pipe (242) are aligned such that to provide steady state flow of incoming secondary stream (223) in line with the outgoing secondary stream (224). In this embodiment of invention, the primary stream is depicted in once through flow configuration and the secondary stream is depicted in recycle flow configuration along with purge mechanism. The enrichment of heavy mercaptans and/or heavy sulphides in the reacted secondary stream (224) is regulated by taking out certain quantity of that stream as bleed or purge (237) and the equivalent quantity replenished by fresh secondary stream (244) and recycled back through pumping mechanism (225) with effective heat integration with the secondary feed/effluent heat exchanger (226) and the steam heater (227).

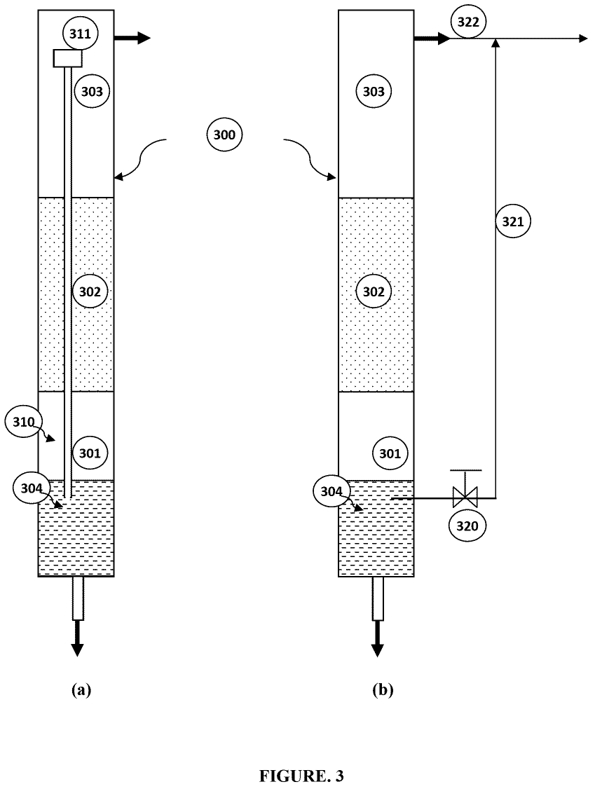

FIG. 3 is a simplified schematic representation of liquid loop pressure control mechanism of reaction vessel of the present invention containing three integrated sections of reactor, separator, and stabilizer in a single system of hydro-processing process as depicted in FIG. 1 or FIG. 2. The steady state flow of secondary stream in liquid phase through the liquid seal of separator is attained by suitable pressure control mechanism as depicted in FIG. 3 (a) or FIG. 3 (b). FIG. 3 (a) represents an internal pressure control mechanism of the integrated staging hydro-processing reaction vessel, in which at least one longitudinal pipe (310) is connected from the disengaging space or top of the liquid seal (304) to the top of stabilizer section (303). The top of the longitudinal pipe is covered with an inverted cap (311) to avoid entrainment of any condensed liquid from top to bottom and also acts as conduit for transfer of any dissolved hydrogen from bottom to top.

FIG. 3 (b) represents an external pressure control mechanism of the integrated staging hydro-processing reaction vessel, in which a pipe (310) is externally connected from the disengaging space or top of the liquid seal (304) to the top of stabilizer section (303) through a regular pressure control valve (320) well known in the field of hydro-processing. The downstream line (321) of the pressure control valve is equalized in pressure to that of the outgoing treated primary stream (322). This external conduit also aids in transfer of any dissolved hydrogen from bottom to top.

The present invention relates to an integrated hydro-processing reaction vessel with effective utilization of multitude of mass transfer stages in reduction of heteroatom present in the hydrocarbon feed. Substantial amount of research work already available in the art of design, configuration, and intensification of hydro-processing process, still prevails enormous scopes for continuous improvement of the hydro-processing. Integration of specific functional heat & mass transfer unit operational equipment along with reactors always remained a cost-effective approach and model for execution of any hydro-processing reactions.

In the present embodiment, an integrated hydro-processing reaction vessel which comprises of all the reactor, separator and stabilization sections integrated together in a single system for hydro-processing process of low boiling hydrocarbon feed undergoing multitude of mass transfer stages with the heavy boiling hydrocarbon feed is disclosed.

The term “reaction vessel” as used herein refers to an integrated hydro-processing reaction vessel comprising of all three sections of reactor, separator, and stabilizer.

The term “primary stream” as used herein refers to the low boiling hydrocarbon feedstock, preferably liquefied petroleum gas (LPG) containing H₂S, mercaptans and other organic sulphur compounds, whose hydrocarbon carbon chain length is preferably of C3, C4 and thereof and its final boiling point temperature is preferably within 70° C. The term “secondary stream” as used herein refers to the heavy boiling hydrocarbon feedstock containing olefinic compounds, whose olefinic carbon chain length varies preferably in the range of C3 to C10 and its overall olefinic concentration is limited to 1% minimum by mass and preferably more than 3% by mass.

The term “hydrogen” as used herein refers to hydrogen gas or hydrogen rich treat gas or hydrogen rich gaseous stream preferably containing hydrogen above 80% by volume more preferably above 90% by volume. The hydro-processed primary stream is called treated primary stream, wherein the heteroatoms are removed and considered to be a finished product or stream. The hydro-processed secondary stream is called reacted secondary stream, wherein the converted heteroatoms like heavy mercaptans, heavy sulphides, etc. are dissolved in it and not considered as a finished product, but having potential of olefin rich components in it and makes capable of recycling or re-utilizing for further hydro-processing using the conventional processes known in the art.

The reaction vessel constitutes of three integrated sections in which the middle section acts as reacting zone, and the remaining two sections act as non-reacting zone. The middle zone acts as the reactor section comprising active catalyst system; above and below which, the upper and lower non-reacting zones are located, respectively. The upper non-reacting zone facilitates the removal of treated low boiling primary stream and the lower non-reacting zone facilitates in the removal of reacted heavy boiling secondary stream. The bottom portion acts as the separator section designed with liquid seal mechanism, by which the entrainment of gas is restricted and neat liquid stream is withdrawn from bottom. The top portion act as the stabilizer section with required disengaging space and the treated vapour stream is withdrawn from top through mesh type coalescer arrangement, by which the entrainment of liquid is stopped.

The catalyst system present in the reactor section is a mixed transition metal-based hydro-processing catalyst, preferably of Co, Ni, Mo, or W on inert support. The catalyst shapes are of any structure like sphere, cylinder, pellet, 2-lobe, 3-lobe, 4-lobe, etc. being utilized as those skilled in the art of hydro-processing. The selection of shape of the catalyst is mainly governed by the permissible pressure drop and the voidage exerted within the catalyst bed. The primary low boiling stream flows from bottom to top due to its inherent nature of vapour phase and the secondary heavy boiling stream flows from top to bottom due to its inherent nature of liquid phase. The primary stream carrying mercaptans and H₂S are rich in its concentration and gradually decreases along the length of the reactor due to reactive mechanism from bottom to top of the catalyst section. The secondary stream carrying olefins, preferably above 3% by mass whose initial boiling range is at least above 90° C. and preferably above 140° C. The concentration of olefins is consistent along the length of the reactor from top to bottom as its reactive consumption is moderate (always above 3% by mass) throughout the catalyst section. The olefins consumed in secondary stream are negligible (0.01 to 0.1 wt. % of the primary stream) as their consumptions are stoichiometrically equivalent to one-on-one mole basis of mercaptans and H₂S present in primary stream.

Under hydrogen environment, the mercaptans and H₂S in vapour phase react with the olefins present in liquid phase and undergoes shift reaction getting them converted into respective products preferably heavy sulphides and/or heavy mercaptans. The boiling range of these reactive shift products is high such that they end up in liquid phase i.e., secondary stream, which flows from the top to bottom of the reaction section. It is well known in the art of hydro-processing, that the mercaptan recombinant reactions with olefins are reversible in nature. The present invention of flow counter configuration of primary and secondary stream aids in multitude of mass transfer of the reactive shift product moving into the secondary stream, which is also considered as sacrificial hydrocarbon solvent stream for removal and carrying out of heavy boiling sulphur compounds formed as reactive shift products. The term solvent is being used to characterize the secondary stream as it behaves like a carrier stream for those removed heteroatom preferably sulphur initially present in the form of mercaptans and H₂S in the primary stream and hence making it a treated sulphur lean low boiling high value primary stream. The shift reaction is very effective in the primary stream as it moves from the bottom to top in reaction section, the reactive product continuously ends up in the counter flowing secondary stream along the entire length of reaction section and drives the equilibrium towards forward in formation of heavy mercaptans or heavy sulphides through multiple mass transfer stages in the integrated reaction vessel. The heavy boiling secondary stream herein; acts as medium for the supply of one the reactants “olefins” and also as a carrying medium like solvent for reactive shift products.

Non-limiting examples of hydro-processing reactor internals which can be practiced in the present invention includes any type of liquid and gas/vapor phase distributors in those skilled in the art. The top liquid distributor, typically of vapour lift liquid distribution tray type as well known in the art, uniformly distributes the down-flow of secondary stream across the entire cross section of reaction vessel along with cross flow mechanism of outgoing up flow of treated primary stream. The bottom gas/vapor distributor uniformly distributes the up flow of primary stream across the entire cross section of reaction vessel along with cross flow mechanism of outgoing down flow of reacted secondary stream.

The reaction vessel of present invention is an integrated process intensified single column vessel or single system comprising of reactor, separator, and stabilizer sections. The reactor section located in the middle of the integrated vessel performs the hydro-processing reactive shift reaction in the presence of catalyst system and the counter flow configuration of both primary and secondary streams along its axial length entire longitudinal of reactor section provides multiple stages of mass transfer between reactant and product. The non-reacting zone below the reactor section is called the separator section and provides separation of hydrocarbon vapour and hydrogen gas of primary stream from the outgoing reacted secondary stream.

The present invention also discloses a self-regulating liquid seal mechanism at the bottom of the reaction vessel in separator section. The associated components of liquid seal mechanism of separator section provide a steady state flow configuration of incoming secondary stream from top to that of the outgoing secondary stream from bottom without entrainment of incoming primary stream in any of the steady or unsteady reaction vessel conditions. The liquid seal comprises of two annular pipes in the bottom most axis location of the reaction vessel, wherein the outer pipe is completely plugged at its top portion and the bottom portion is designed with perforation or wedge gap around its entire circumference for the entry of outgoing secondary stream into the liquid seal. The inner pipe of liquid seal is concentric to the outer pipe with reduced height of internally protruded part (119 or 242) and externally protruded part (116 or 236) from bottom of the reaction vessel, whose volume is 0.5 to 10 times that of the liquid hourly volumetric flow rate of primary stream. The reacted secondary stream enters the liquid seal from the bottom portion of outer pipe designed with perforation and moves upward inside the annular portion and leaves the reaction vessel from the top portion of the inner pipe wherein the liquid head equivalent to the height of internally protruded inner pipe permanently provides a barrier or sealing mechanism for the entrainment of any primary stream from the reaction vessel at bottom. Thus, the liquid seal makes the unreacted primary stream entering in the top of the separator section or the bottom of the reactor section forcefully need to pass the reactor section in upward flow configuration by ensuring necessary hydroprocessing reaction. The height and diameter of the internally projected outer pipe, inner pipe and the internal annular clearance are designed to ensure steady flow of secondary stream and static liquid sealing mechanism.

The non-reacting zone above the reactor section is called the stabilizer section and provides the separation of treated hydrocarbon vapour and hydrogen gas of primary stream from the incoming unreacted secondary stream. The overall height of the stabilizer section is designed such that the disengaging space for the outgoing treated primary stream in vapour phase is free from entrainment of liquid by accounting to the terminal velocity of liquid droplets generated from the secondary stream. The concentration of the treated primary stream is enriched with low boiling hydrocarbon as the hydrogen (117 or 240) involved in the hydro-processing is very minimal with respect to the volumetric ratio hydrogen to that the primary stream in the range of 0.5 to 10 Nm³/m³ at normal conditions of temperature and pressure (NTP). The effective utilization of phase difference between the treated vapour phase hydrocarbon stream and the reactive products of liquid phase ending up in secondary stream is the substantial reason and advantage for integration of treated primary stream separation or vapour phase stabilization at the top of the reaction vessel. The treated primary stream flows across any typical mesh type coalescer arrangement at the topmost section of the stabilizer section to nullify the entrainment fine liquid particle during the stage of process upsets. The volume, diameter, and height of the stabilizer section is designed in such a way that steady flow incoming and outgoing primary stream well within the flooding regime of any counter current operation is ensured. The treated primary stream from the top of stabilization section is routed to a reflux drum related accessories for further separation and the same can be achieved by conventional means known in the art and hence are not discussed here. The treated primary stream post heat exchange in reflux drum separates non condensable hydrogen gas and the condensed liquid phase primary stream is taken out as finished product/treated stream. The hydrogen gas retrieved from the recycle drum may or may not be recycled back for further utilization in place of makeup hydrogen (117 or 240).

In one of the embodiments, the present invention of integrated hydroprocessing reaction vessel is described under isothermal conditions of heat integration and once-through configuration. In another embodiment of the present invention, the same is described under adiabatic conditions of heat integration and recycle configuration. The primary stream effectively utilizes heat in either case of isothermal or adiabatic reactor system and enters the bottom of the reactor section, moving upward and eventually comes out at the topmost of the stabilization section. The secondary stream effectively supplies heat and gains minimal required heat from external source in either case of isothermal or adiabatic reactor system and enters at the top of the reactor section, moving downward and eventually comes out at the bottom most of the separator section.

The FIG. 1 is a simplified schematic representation of reaction vessel (100) of the present invention containing three integrated sections of reactor, separator and stabilizer integrated in a single system of hydroprocessing under isothermal conditions and once-through configuration. The reactor section of the vessel is an isothermal reactor, shell/wall mounted by electric furnace and the stabilizer and separator sections are hot insulated in nature. The primary stream along with hydrogen enters the reactor section through a non-contacting concentric pipe to the reaction vessel and gains heat energy from the reactor section to the desired level of reaction temperature and attains vapour phase by virtue of its inherent low boiling hydrocarbon feedstock and eventually enters through the vapour phase distributor (114) and makes upward flow from bottom to top of the reactor section. The secondary heavy boiling hydrocarbon stream enters through the liquid phase distributor (110) and makes downward flow from top to bottom of the reactor section and gains heat to the desired level of reaction temperature in the top layer of reactor section below liquid distributor acts as a preheating zone. The reactive shift reaction mechanism of organic sulphur reactant in primary stream and the olefinic reactant in the secondary stream converts reactive products of heavy boiling sulphur compounds ending up in secondary stream wherein the continuous removal of reactive products into secondary stream along the length of the reactor undergoes compounded number of stages in the integrated hydro-processing reaction vessel. The primary and secondary streams are depicted in simple once through flow configuration with effective heat utilization from the electric furnace, mainly opted for small scale integrated staging hydro-processing operation.

The FIG. 2 is a simplified schematic representation of reaction vessel (200) of the present invention containing three integrated sections of reactor, separator and stabilizer integrated in a single system of hydro-processing under adiabatic conditions and recycle configuration mainly opted for large scale integrated staging hydro-processing operation. The primary stream along with hydrogen enters the reactor section through two series of feed/effluent heat exchangers (238 and 226) and gains heat energy from the outgoing primary & secondary effluent streams to the desired level of reaction temperature and attains vapour phase by virtue of its inherent low boiling hydrocarbon feedstock and eventually enters through the vapour phase distributor (234) and makes upward flow from bottom to top of the reactor section. This vaporization of primary hydrocarbon stream is further aided by addition of fresh makeup hydrogen stream (240). The secondary heavy boiling hydrocarbon stream is heat integrated with the secondary stream feed/effluent exchanger (226) and achieves desired reaction temperature from the external source of steam heater (227) and enters through the liquid phase distributor (232) (describe) and makes downward flow from top to bottom of the reactor section. The reactive shift reaction mechanism of organic sulphur reactant in primary stream and the olefinic reactant in the secondary stream converts reactive products of heavy boiling sulphur compounds ending up in secondary stream wherein the continuous removal of reactive products into secondary stream along the length of the reactor undergoes compounded number of stages in the integrated hydroprocessing reaction vessel. The primary stream is in once through flow configuration and the treated stream (239) is routed to a reflux drum (not shown in FIG. 2) in which the liquefied low boiling hydrocarbon is taken out as finished product and the off-gas hydrogen taken from reflux drum vessel can be recycled or reutilized along with the fresh makeup hydrogen stream (240). The treated primary stream from the top of stabilization section is routed to a reflux drum related accessories for further separation and the same can be achieved by conventional means known in the art and hence are not discussed here. The olefinic reactant being surplus and as the concentration of heavy sulphides are minimal (as equivalent to the mercaptans in primary stream) initially in the reacted secondary stream and hence the reacted secondary stream is rerouted or recycled back into the reaction vessel post effective heat integration and meanwhile the reactive product of heavy boiling sulphur compounds like heavy meracaptans or heavy sulphides are accumulating and get enriched in the secondary stream. In order to regulate the concentration of accumulating heavy boiling sulphur compounds, a purge stream (237) is taken out as bleed and compensated with the fresh secondary stream (244). The criteria for defining the bleed rate (0.1 to 5% of the volumetric flow rate of outgoing reacted secondary stream) of purge stream (237) is directly proportional to the concentration of total organic sulphur compound (typically the organic sulphur in fresh makeup secondary stream is allowed to incrementally increase by 10 to 50% by mass of its original organic sulphur concentration) in the reacted secondary stream (224), which tends to cumulatively increase based on the incoming organic sulphur compounds of primary stream.

The challenge of loading and flooding in the reactor section containing catalyst bed always prevails in a counter flow operation of primary and secondary stream. A similar challenge encountered over here is controlled and regulated through the flow rate of primary stream by maintaining within 30% to 50% of its flooding velocity for a defined secondary stream velocity. The selection of catalyst shape and the voidage among catalyst particles also plays a critical role in facilitating or regulating the superficial velocity of primary stream. The maldistribution of the reactor section filled with solid transient metal based hydroprocessing catalyst is nullified when the voidage of any definite shape catalyst bed falls in the range of 20 to 50%, more preferably 25 to 35%.

The overall sizing of reaction vessel either in FIG. 1 or FIG. 2 with respective independent sizing of integrated components of reactor, separator, and stabilizer mainly depends upon several parameters. The volume of catalyst containing reactor section is mainly governed by the concentration of organic sulphur compounds present in the primary stream and its required conversion level of hydroprocessing. The volume of reactor section (108/230) is defined as the volume equivalent to 0.5 to 5 liquid hourly space velocity (LHSV) of the primary stream and cumulatively observed to occupy around 20 to 40% of the volume of entire reaction vessel. The nature of boiling range of primary stream and its treating quantity along with the hydrogen rich treat gas cumulatively defines the volume of the stabilizer section, turns out to occupy around 60 to 80% of the volume of the reactor section. The concentration of olefins in the secondary stream and its nature of boiling range cumulatively defines the volume of the separator section, turns out to occupy around 40 to 60% of the volume of the reactor section. The dimension of the concentric pipes (both inner and outer) associated in the liquid sealing mechanism of the separator is directly proportional to the superficial velocity of the secondary stream. The top distributor meant for distribution of liquid secondary stream across the cross section of reaction vessel shall also contains the provision for escaping vapours of treated primary stream into the stabilizer section. The bottom distributor meant for distribution of vapour phase primary stream across the cross section of reaction vessel are of localized multiple nozzle or sparger type assemblies as already known the art and shall also contains the provision for free flow drain of reacted secondary stream into the separator section.

Whereas the principal inventive concept has been described in this provisional patent application, the invention will be fully and particularly described in the complete patent application pursuant hereto.

We claim:

1. An integrated staging hydro-processing reaction vessel (100, 200) for hydro-processing a low boiling vapour hydrocarbon stream which acts as a primary stream and a heavy boiling liquid hydrocarbon stream which acts as a secondary stream, wherein the vessel (100, 200) comprises:
a top portion or a non reacting zone acting as a stabilizer section (107, 229) with a disengaging space consisting of a demister (106, 228) to prevent liquid entrainment at a top part of the stabilizer section (107, 229);
a middle portion or a reaction zone acting as a reactor section (108, 230) consisting of a hydro-processing catalyst bed (111, 233) in a middle part of the reactor section (108, 230), a liquid phase distributor (110, 232) located at a top part of the reactor section (108, 230), and a vapour phase distributor (114, 234) located at a bottom part of the reactor section (108, 230), wherein the secondary stream (103, 223) of heavy boiling hydrocarbons enters the top part of the reaction zone through the liquid phase distributor (110, 232), and the primary stream (101, 221) along with a hydrogen rich treat gas stream (117, 240) enters the bottom part of the reaction zone and get distributed through the vapour phase distributor (114, 234), wherein a volumetric ratio of hydrogen to the primary stream is in the range of 0.5 to 10 Nm³/m³;
a bottom portion or a non reacting zone acting as a separator section (109, 231) integrated with a liquid seal mechanism (115, 235) containing an inverted outer pipe (118, 241), wherein the inverted outer pipe (118, 241) has a seal at a top part and a perforated opening (120, 243) at a bottom part thereof, and an inner annular pipe (119, 242) having an externally protruded part (116, 236) extending out from the separator section (109, 231); and
wherein in the reactor section (108, 230), the reaction between sulphur compounds of the primary stream (101, 221) and the olefins of the secondary stream (103, 223) results in formation of heavy boiling sulphur compounds in liquid state and heteroatom lean low boiling stream (102, 222), wherein the heavy boiling sulphur compounds are in liquid-phase and taken out from the reaction vessel through an outgoing secondary stream (104, 224) and the heteroatom lean low boiling stream (102, 222) is withdrawn from a topmost section of reaction vessel (100).

2. The reaction vessel (100, 200) as claimed in claim 1, wherein the demister (106, 228) is made of a mesh type coalescer arrangement which is adapted to restrict the entrainment of liquid, and a treated vapour stream is withdrawn from the top part through the mesh type coalescer arrangement.

3. The reaction vessel (100, 200) as claimed in claim 1, wherein the reactor section (108, 230) has a volume equivalent to 0.5 to 5 liquid hourly space velocity (LHSV) of the primary stream.

4. The reaction vessel (100, 200) as claimed in claim 1, wherein the volume of reactor section is 20 to 40% of a volume of the entire reaction vessel (100, 200) governed by extent of hydroprocessing and the concentration of reactants in the primary and secondary streams.

5. The reaction vessel (100, 200) as claimed in claim 1, wherein the volume of separator section is 40 to 60% to the volume of reactor section and a volume of the stabilizer section is 60 to 80% to the reactor section.

6. The reaction vessel (100, 200) as claimed in claim 1, wherein the primary stream is effectively heat integrated and moves upward through the reactor section (108, 230) and a treated primary stream comes out through a top part of the stabilizer section (107, 229), the secondary stream (103, 223) is effectively heat integrated and moves downward in the reactor section (108, 230) and the reacted secondary stream comes out through a bottom part of the separator section (109, 231),

7. The reaction vessel (100, 200) as claimed in claim 1, wherein, inside the reactor section (108, 230) the primary stream and the secondary stream undergoes hydro-processing along an entire length of the reactor section (108, 230), and wherein the secondary stream (103, 223) exothermically reacts with the primary stream (101, 221) and generates in-situ heat load.

8. The reaction vessel (100, 200) as claimed in claim 1, wherein the primary stream (101, 121) consists of low boiling hydrocarbons and sulphur compounds, and a flow rate of the primary stream is controlled and regulated within 30% to 50% of a flooding velocity regime thereof, wherein the secondary stream (103, 223) of heavy boiling hydrocarbons is in liquid phase and consist of olefinic compounds, wherein the said primary and secondary streams are integrated for effective heat utilization with minimal supply of heat energy from an external source.

9. The reaction vessel (100, 200) as claimed in claim 1, wherein the inner annular pipe (119, 242) has a height lesser than the outer inverted pipe (118, 241) and both are aligned to provide steady state flow of the secondary stream (103, 223) in line with the outgoing secondary stream (104, 224), and wherein the externally protruded part (116, 236) is adapted for self-regulating the liquid seal mechanism (115), through the liquid seal mechanism (115, 235) the ingress of gaseous primary stream is restricted and the reaction converted heavy boiling sulphur compounds comes out from the reaction vessel (100, 200) along with the secondary stream (104, 224).

10. The reaction vessel (100, 200) as claimed in claim 1, wherein the stabilizer section (107, 229) has a height to enrich the concentration of heteroatom lean low boiling stream (102, 222), wherein the low boiling stream (102, 222) is withdrawn from a topmost section of reaction vessel (100, 200) through the demister (106, 228) by which the entrainment of liquid is stopped.

11. The reaction vessel (100, 200) as claimed in claim 1, wherein the liquid phase distributor (110, 232) consists of a vapour lift liquid distribution tray, and the vapour phase distributor (114, 234) consists of a multiple sparger type nozzle located across a circumference of the reaction vessel at a standard pitch distance.

12. The reaction vessel (100) as claimed in claim 1 further comprises:
a reactor mounted furnace (112) covering the reactor section (108), wherein the hydro-processing catalyst (111) present in the reactor section (108) achieves a desired temperature of hydro-processing from the reactor mounted furnace (112); and
a longitudinal pipe (105) extending through a pathway (113) from the stabilizer section (107) to the reactor section (108), wherein the longitudinal pipe (105) have an upper end located above the stabilizer section (107) and a lower end located below the reactor section (108), wherein, the vapour phase distributor (114) is connected with the lower end of the said longitudinal pipe (105).

13. The reaction vessel (100) as claimed in claim 12, wherein the primary stream (101) along with the hydrogen rich treat gas (117) gains heat from the reactor section (108) in the pathway (113) to the vapour phase distributor (114), and the heat from the reactor section (108) converts primary stream (101) into a vapour phase and resulting in upward movement.

14. The reaction vessel (200) as claimed in claim 1 further comprises:
a steam heater (227) adapted to provide desired temperature to the secondary stream (223); and a primary stream heat exchanger (238) and a secondary stream heat exchanger (226), wherein the primary stream (221) gets an initial heat duty from the primary stream heat exchanger (238) and a final heat duty from the secondary stream heat exchanger (226).

15. The reaction vessel (200) as claimed in claim 14 further comprises an outgoing secondary stream enrichment section connected with the outgoing secondary stream (224), wherein, the enrichment section consists of a purge section (237) adapted to bleed out definite quantity from the outgoing secondary stream (224), a fresh secondary stream input (244) post purging (237) adapted to provide an equivalent quantity of the fresh secondary stream, and a pumping mechanism (225) adapted to recycle the outgoing secondary stream (224) along with the fresh secondary stream back into the reactor section.

16. The reaction vessel (200) as claimed in claim 1, wherein the hydro-processing catalyst bed (111, 233) consist of a solid transient metal hydro-processing catalyst, and the catalyst bed has a voidage in a range of 20 to 50%, more preferably in a range of 25 to 35%.
